(19) United States
(12) Patent Application Publication
(10) Pub. No.: US 2021/0207248 A1
(43) Pub. Date: Jul. 8, 2021

(54) NICKEL-GOLD ALLOY AND METHODS OF FORMING THE SAME

(71) Applicant: Xtalic Corporation, Marlborough, MA (US)

(72) Inventors: Robert D. Hilty, Walpole, MA (US); Evgeniya Freydina, Acton, MA (US); Robert Legg, Chelmsford, MA (US)

(73) Assignee: Xtalic Corporation, Marlborough, MA (US)

(21) Appl. No.: 16/734,621

(22) Filed: Jan. 6, 2020

(51) Int. Cl. C22C 19/05; C25D 3/12

(52) U.S. Cl. CPC C22C 19/058; C25D 3/12

(57) ABSTRACT

Nickel-gold alloys and methods of forming the same.

### TECHNICAL FIELD

The present invention generally relates to nickel-gold alloys as well as methods of forming the same.

### BACKGROUND

Metal alloys find many uses in the design and fabrication of articles. Such articles may be used in a variety of applications including in the electronics space such as electrical connectors. Different applications may have different performance/property requirements. For example, for certain electrical connector applications, properties such as hardness, ductility, electrical resistivity and corrosion resistance may be important. The composition and structure of alloys may be designed to provide certain property enhancements.

### SUMMARY

Nickel-gold alloys as well as methods of forming the same are provided.

In one aspect, an article is provided. The article comprises a nickel-gold alloy. Gold is present in the nickel-gold alloy at a gold concentration no greater than 10 atomic percent.

In one aspect, a method is provided. The method comprises electrodepositing a nickel-gold alloy. Gold is present in the nickel-gold alloy at a gold concentration no greater than 10 atomic percent.

Other aspects, embodiments, and features of the invention will become apparent from the following detailed description. All patent applications and patents incorporated herein by reference are incorporated by reference in their entirety. In case of conflict, the present specification, including definitions, will control.

### DETAILED DESCRIPTION

Nickel-gold alloys and methods of forming the same are generally described. Such nickel-gold alloys (also referred to herein as “Ni/Au alloys”) may be used in a variety of articles including electrical connectors. The Ni/Au alloy may be in monolithic form (e.g., free of any overlying/underlying layers/regions) or may be a layer that is present in combination with one or more other material(s), as described further below. In some embodiments, the Ni/Au alloy is formed using an electrodeposition method. In some embodiments, the Ni/Au alloy comprises a majority of nickel and, for example, may include a gold concentration of no greater than 10 atomic percent (at %). The Ni/Au alloys described herein may can offer several advantages. For example, in some embodiments, articles comprising the Ni/Au alloy may have a high electrical conductivity, improved ductility, improved fatigue strength and more favorable performance in corrosion testing (e.g., salt spray testing).

The Ni/Au alloys described herein may vary in atomic percentage (at %) of different species (e.g., nickel, gold) present. As noted above, the nickel concentration may be greater than the gold concentration. That is, the atomic concentration of nickel in the alloy is greater than the atomic concentration of gold in the alloy. In some embodiments, the atomic percent of gold (e.g., a gold concentration) is no greater than 10 at %, no greater than 5 at %, no greater than 3 at % or no greater than 1 at %. In some embodiments, the gold concentration of the Ni/Au alloy is at least 0.5 at %, at least 1 at %, at least 3 at %, or at least 5 at %. Combinations of the above-referenced ranges are also possible (e.g., an atomic percent of at least 0.5 at % and no greater than 10 at %). It should be understood that other concentrations are possible.

In some embodiments, the Ni/Au alloy is a binary alloy. That is, no additional metals are present in the Ni/Au alloy.

In some embodiments, one or more additional metals may be present in the Ni/Au alloy. The additional metals may be, for example, chromium, tungsten, molybdenum, copper, silver, amongst others. In some embodiments, Ni/Au alloy may contain at least 0.5 atomic %, at least 1 atomic %, at least 5 atomic % or at least 10 atomic % of the additional metal(s) (e.g., a third metal), while the rest of the atomic percentage is composed of nickel and/or gold within the ranges described above such that the total atomic percentage of nickel, gold, and any other metals is 100%. In some embodiments, Ni/Au alloy may contain less than 20 atomic %, less than 10 atomic %, less than 5 atomic % or less than 1 atomic % of the additional metal(s) (e.g., a third metal), while the rest of the atomic percentage is composed of nickel and/or gold within the ranges described above such that the total atomic percentage of nickel, gold, and any other metals is 100%.

In some embodiments, the additional element in the Ni/Au alloy is chromium and a ternary alloy is formed. In such embodiments, without wishing to be bound by theory, the resulting Ni/Au/Cr alloy may have improved hot oxidation performance through the formation of a chromium oxide layer at the surface.

According to some embodiments, the Ni/Au alloy described herein may have a nanocrystalline structure. That is, the alloy has a nanocrystalline grain size. Without wishing to be bound by theory, nanocrystalline microstructures may comprise nanoscale grains that provide improved strength and enhance the articles resistant to wear compared to articles with larger sized microstructures. These grains may be thermodynamically stable and may reduce diffusion of a metal the substrate, which reduces oxidation-based corrosion. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. In some embodiments, gold is positioned proximate to grain boundaries within the alloy.

In some embodiments, at least a portion of the Ni/Au alloy may have an amorphous structure. As known in the art, an amorphous structure is a non-crystalline structure characterized by having no long-range symmetry in the atomic positions. Examples of amorphous structures include glass, or glass-like structures.

In some cases, the Ni/Au alloy may have a microstructure in which the number-average size of crystalline grains (i.e., grain size) may, in some embodiments, be no greater than 200 nm, no greater than 100 nm, no greater than 50 nm, no greater than 25 nm or no greater than 10 nm. In some embodiments, the number-average size of crystalline grains may be greater than 10 nm or greater than 25 nm. It should be understood that all suitable combinations of the above-noted ranges are possible.

As noted above, the Ni/Au alloy may have a larger atomic percentage of nickel and a smaller atomic percentage of gold. In some cases, the gold atoms may be positioned closer to the grain boundaries relative to the center of a crystallite. Without wishing to be bound by any theory, in these alloys, gold atoms may segregate to the grain boundaries, decreasing the grain size with the increase of the gold content in the alloy. This may also allow the alloy to maintain structural (e.g., grain size structure) stability and/or physical stability at elevated temperatures (e.g., at least 200° C., at least 250° C., at least 300° C., at least 350° C., or at least 400° C.). In some cases, the Ni/Au material exhibits little or no change in grain size upon exposure to elevated temperatures for a substantial period of time. In some cases, the grain size of the Ni/Au layer changes by no more than 30 nm, no more than 20 nm, no more than 15 nm, or no more than 10 nm following exposure to a temperature of at least 200° C. In some cases, the grain size of the Ni/Au layer changes by no more than 30 nm, no more than 20 nm, no more than 15 nm, or no more than 10 nm.

In some cases, the Ni/Au alloy has a single phase. As used herein, a “single phase” refers to a composition such that metals present are mixed homogenously as to form a solid solution. In some embodiments, the Ni/Au material is formed or electrodeposited such that the entire layer is in a single phase.

In some embodiments, as noted above, the Ni/Au alloy may be in monolithic form (e.g., produced in monolithic form). As described herein, a “monolithic” material or alloy refers to a material free of additional material layers/regions. It should be understood that when the Ni/Au alloy is produced in monolithic form, in some cases, additional materials (e.g., one or more layers) may be formed on the Ni/Au alloy; or, in other cases, the Ni/Au alloy may remain in monolithic form during use.

According to some embodiments, the articles described herein may include a substrate on which the Ni/Au layer is formed. A variety of different substrates may be suitable. In some cases, the substrate may comprise an electrically conductive material, such as a metal, metal alloy, intermetallic material, or the like. Non-limiting examples of suitable substrates include copper and silicon. The substrate may be in the form of a variety of shapes and dimensions. For example, the substrate may be a strip. In some cases, the substrate may be perforated. In some cases, the substrate may be a discrete component.

In some cases, the Ni/Au alloy covers substantially the entire outer surface area of the substrate. In some cases, the Ni/Au alloy only covers a portion of the outer surface area of the substrate. For example, the Ni/Au alloy may only cover one outer surface of the substrate. In some cases, portions of the substrate may be masked when forming the coating so that the Ni/Au alloy is formed selectively on certain portions of the substrate while leaving other portions of the substrate uncoated. In some embodiments, the Ni/Au alloy may be selectively deposited (e.g., using a mask) when being formed. That is, the Ni/Au alloy may cover only a portion of the outer surface area of the underlying layer or substrate.

In some embodiments, the resulting article may include one or more layers (e.g., metal and/or metal alloy layers). In some embodiments, the one or more additional layers may be between the substrate and the Ni/Au alloy and/or formed on the Ni/Au alloy layer. In some embodiments, the article includes only a Ni/Au alloy layer formed on the substrate. In some embodiments, the Ni/Au alloy layer may be the uppermost layer formed on the substrate.

When additional layers are present, the layers may have a variety of compositions including metal and/or metal alloy layers. Suitable compositions include metal and/or metal alloy layers described in commonly-owned U.S. Pat. No. 9,765,438 (e.g., other nickel-based alloy layers such as Ni/W alloys or Ni/Mo alloys); U.S. Pat. No. 9,694,562 (e.g., silver-based alloy layers such as Ag/W alloys or Ag/Mo alloys); and U.S. Patent Publication Number 2017-0253008 (e.g., precious metal layers such as Ru, Rh, Os, Jr, Pd, Pt, Ag, and/or Au including alloys formed therefrom; and, platinum group metal layers including Ru, Rh, Os, Jr and/or Pt including alloys formed therefrom), each of which is incorporated herein by reference in its entirety.

According to some embodiments, the Ni/Au alloy can be further hardened through modest heat treatment (300° C./lhr). Without wishing to be bound by theory, this modest heat treatment leads to grain boundary relaxation which can strengthen the material. In some cases, higher and lower heat treatment temperatures and time-temperature combinations can be used to achieve this hardening.

When a layer is referred to as being “on” another layer or the substrate, it can be directly on the layer or the substrate, or an intervening layer or intervening layers may be present between the layer(s) or layer and substrate. A layer that is “directly on” another layer or substrate means that no intervening layer is present.

According to certain embodiments, Ni/Au alloys (e.g., in layer form or in monolithic form) may have a thickness of at least up to 1 mm. In some embodiments, the alloy may have a thickness of at least 10 μm, at least 25 μm, at least 50 μm, at least 100 μm, at least 500 μm, or at least 1 mm (i.e., 1000 μm). In some embodiments, the thickness of the alloy is no greater than 1 mm, no greater than 500 μm, no greater than 100 μm, no greater than 50 μm, no greater than 25 μm or no greater than 10 μm. Combinations of the above-reference ranges are also possible (e.g., no greater than 750 μm and at least 1 μm). It should be understood that other thicknesses are also possible.

As noted above, according to some embodiments, the Ni/Au alloy may be useful in connecting two (or more) electrical components. The inventors have recognized and appreciated that Ni/Au alloys may have unexpectedly good properties including certain mechanical properties (e.g., ductility, fatigue strength) and electrical properties (e.g., high conductivity, corrosion resistance) which make the alloy particularly well suited for electrical connector applications. For example, the Ni/Au alloy may demonstrates a strength that can exceed 2 GPa, in some embodiments. In some cases, reverse cycle bend testing for fatigue performance shows that a monolithic electroformed Ni/Au alloy can exceed 1 million cycles at a stress level of 1 GPa.

The Ni/Au alloy, according to some embodiments described herein, has demonstrated improved durability in a salt spray environment (e.g., as per ASTM B117) with reduced galvanic attack during salt spray exposure. This may make the Ni/Au alloy particularly well-suited for connector applications requiring harsh environmental condition. As noted above, the Ni/Au alloy may also be used in conjunction with one or more other layers, such as a Rh—Ru alloy layer, in order to produce a plated stack that has outstanding powered immersion corrosion performance.

As noted above, the Ni/Au alloy (and any other layers or material present) may be formed using an electrodeposition process. Electrodeposition generally involves the deposition of a material (e.g., electroplate) on an electrode by flowing electrical current between two electrodes through an electrodeposition bath, i.e., due to a difference in electrical potential between the two electrodes. For example, methods described herein may involve providing an anode, a cathode, an electrodeposition bath (also known as an electrodeposition fluid) associated with (e.g., in contact with) the anode and cathode, and a power supply connected to the anode and cathode. In some cases, the power supply may be driven to generate a waveform for producing a layer.

The electrodeposition process(es) may be modulated by varying the potential that is applied between the electrodes (e.g., potential control or voltage control), or by varying the current or current density that is allowed to flow (e.g., current or current density control). In some embodiments, the layer may be formed (e.g., electrodeposited) using direct current (DC) plating, pulsed current plating, reverse pulse current plating, or combinations thereof. In some embodiments, reverse pulse plating may be preferred, for example, to form a barrier layer. Pulses, oscillations, and/or other variations in voltage, potential, current, and/or current density, may also be incorporated during the electrodeposition process, as described more fully below. For example, pulses of controlled voltage may be alternated with pulses of controlled current or current density. In general, during an electrodeposition process an electrical potential may exist on the substrate to be coated, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.), as described more fully below.

According to some embodiments, nanostructured Ni/Au alloys (e.g., with up to 10 atomic percent gold) can be produced by electrodeposition methods, as described above, which allow atom-by-atom building of an oversaturated solid solution. The above alloys can be electrodepo sited from aqueous solutions of nickel salts and/or gold salts, such as chlorides or sulfates, with the addition of gold compounds, such as auric chloride. Electrodeposition baths may also contain complexing agents, such as citrates, borates, 5,5-dimethylhydantoin (DMH), glycine or any other suitable agents and pH buffering components, such as carbonates and phosphates. Leveling and wetting agents may also be added to produce smooth deposits.

The following examples are intended to illustrate certain embodiments of the present invention, but do not exemplify the full scope of the invention.

### Example 1

The following example described the preparation and characterization of Ni/Au alloys on a copper substrate.

Ni/Au alloy layers, about 20 μm thick, were electroplated on copper substrates from a solution, containing DMH (dimethylhydantoin), sodium borate, sodium sulfate and auric acid. Crystallite size was determined by X-ray diffraction. The samples were cross sectioned, and hardness was measured by Vickers hardness test, as shown below in Table 1.

TABLE 1

| Alloy composition | Crystallite size, nm | Hardness, HV |
|---|---|---|
| 1.2 at % Au | 15 | 584 |
| 3.0 at % Au | 14 | 644 |

### Example 2

The following example described the preparation and characterization of Ni/Au alloys samples and a pure Ni sample on a silicon wafer.

Electrical conductivity data is shown in Example 2 below, according to one set of embodiments. Ni/Au alloy layers were plated on a silicon wafer from a solution, containing DMH (dimethylhydantoin), sodium borate, sodium sulfate and auric acid. A pure nickel layer was plated from a commercial nickel sulfamate plating bath for comparison. Electrical resistivity of the obtained layers was measured by 4-point probe (according to ASTM F84-99) which are presented in Table 2.

TABLE 2

| Alloy composition | Film thickness, μm | Resistivity, μOhm*cm |
|---|---|---|
| Pure Ni | 13 | 10.2 |
| 2.2 at % Au | 14 | 11.2 |
| 5.6 at % Au | 19 | 14.6 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a nickel-gold alloy,
wherein gold is present in the nickel-gold alloy at a gold concentration no greater than 10 atomic percent.

2. A method, comprising:
electrodepositing a nickel-gold alloy;
wherein gold is present in the nickel-gold alloy at a gold concentration of no greater than 10 atomic percent.

3. The article of claim 1, wherein the nickel-gold alloy has a nanocrystalline grain size.

4. The article of claim 1, wherein the nickel-gold alloy has a grain size of less than 100 nm.

5. The article of claim 1, wherein the nickel-gold alloy is in the form of a layer.

6. The article of claim 1, further comprising a substrate and wherein the layer is formed on the substrate.

7. The article of claim 1, wherein the nickel-gold alloy is in monolithic form.

8. The article of claim 1, wherein the nickel-gold alloy comprises a third metal.

9. The article of claim 1, wherein the third metal is chromium.

10. The article of claim 1, wherein the gold concentration no greater than 5 atomic percent.

11. The article of claim 1, wherein gold atoms are positioned proximate to grain boundaries within the alloy.

12. The article of claim 1, wherein the article comprises an additional layer comprising a metal and/or metal alloy.

13. The article of claim 1, wherein a thickness of the nickel-gold alloy is no greater than 1 millimeter.

14. The article of claim 1, wherein a thickness of the nickel-gold alloy is at least 100 μm.

15. The article of claim 1, wherein the article is an electrical connector.

16. The article of claim 1, wherein the nickel-gold alloy is a binary alloy.

17. The article of claim 1, wherein the nickel-gold alloy is a solid-solution.
